(19) United States
(12) Patent Application Publication
(10) Pub. No.: US 2017/0114770 A1
(43) Pub. Date: Apr. 27, 2017

(54) MODULAR LATTICE WAVE MOTION ENERGY CONVERSION APPARATUS

(71) Applicant: Matthew Laurence Lewis, Brooklyn, NY (US)

(72) Inventor: Matthew Laurence Lewis, Brooklyn, NY (US)

(21) Appl. No.: 15/269,004

(22) Filed: Sep. 19, 2016

Related U.S. Application Data
(60) Provisional application No. 62/246,018, filed on Oct. 24, 2015.

(51) Int. Cl. F03B 13/20; H02K 11/04; H02K 7/18

(52) U.S. Cl. CPC F03B 13/20; H02K 7/18; H02K 11/04; F05B 2220/706; F05B 2260/30; F05B 2250/282

(57) ABSTRACT

An improved ocean wave energy collecting apparatus for extracting power, comprised of a plurality of module members in a lattice formation, moored as a group to the seabed via tether(s), each module reacting to each adjacent module, and to the apparatus' seabed mooring, in response to the orbital motion of water particles in ocean waves. A collection of modules is arranged and interconnected in crystal-like lattice layers, such that each module has rotation and/or linear motion in relation to an adjacent module as ocean wave energy passes, and is captured, by the apparatus.

### CROSS-REFERENCE TO RELATED APPLICATION

This application claims the benefit of U.S. Provisional Patent Application No. 62/246,018, filed Oct. 24, 2015, which is incorporated by reference in its entirety.

### BACKGROUND OF THE INVENTION

The present invention relates to an apparatus and method for converting ocean wave motion to energy.

The potential of ocean wave energy as a stable, reliable source of energy is enormous. It is estimated that total worldwide available ocean wave power is on the order of 1-10 TW. This lays bare an enormous opportunity, if the right wave power collection solution presents itself.

The energy available in a unique propagating ocean wave can be calculated from:

$$E = \frac{ρℊ {H}^{2} L}{8}$$

### Where,

E=total energy in a wave per unit crest width
ρ=density of water
g=acceleration due to gravity
H=wave height
L=wave length
Thus, ocean wave energy is proportional to the square of wave height.

Wave energy is generated via wind, and solar energy. Thus wave energy is essentially a form of wind and solar energy. Unlike wind and solar energy, which is intermittent, and unpredictable, ocean wave energy is nearly consistent, and highly predictable. Potentially available at such enormous scales, it is a great reservoir of untapped energy looking for the proper solution to tap it.

Impediments to implementation of wave energy converters on the macro scale arise primarily due to survivability, and efficiency. Any ocean wave energy convertor must be able to survive in severe storm conditions, where rare rogue waves, and violent water motion, can have great destructive power.

Further, the device must be able to capture a maximum amount of wave energy available at any time.

Today's devices, surprisingly, allow great amounts of propagating ocean waves to flow past, not fully realizing the capture potential and the density of energy available at any particular ocean area that is tapped for an energy resource. Furthermore, even at a particular location where a wave energy convertor sets out to capture energy, the totalorbital motion available as an energy source at that location is not maximally absorbed, captured and converted. Typically only a decomposed arc of the motion, whether in the form of the to-and-fro component of the motion (surge), or the up-and-down component of the motion (heave), is captured. Issues with survivability of existing devices prevent confidence in investment needed to move these projects forward. A wave energy convertor must simultaneously be durable and efficient, capturing the maximum amount of the energy density available at any location.

Examples of apparatuses that have been proposed include U.S. Pat. No. 8,358,025 to Hogmoe, which is incorporated by reference, which discloses an array of buoyant bodies and at least one energy-generator connected to one or more moveable links and forming a part of each link. However, the device fails to capture any reaction between multiple buoyant and negatively buoyant layers connected vertically and horizontally in a lattice structure.

U.S. Patent Application No. 2011/0308244, likewise incorporated by reference, teaches a device in which an array of members connected together to form a structure having link members, nodes and absorbers, wherein the relative motion of at least some of the members of the array, is convertible to another form of energy. This disclosure likewise fails to take advantage of the full orbital motion of ocean waves, using modules vertically and horizontally connected to one another.

U.S. Patent Application 2011/0304144, likewise incorporated by reference, describes a layer of pods in a wave motion energy conversion apparatus, arranged in such a way as to leverage the vertical heave of the waves

None of the foregoing prior art devices takes advantage of the full orbital motion of ocean waves using a multi-layer lattice structure.

### SUMMARY OF THE INVENTION

In one aspect, the invention is an apparatus for extracting power from wave motion in seawater over a sea floor, comprising: a lattice structure comprised of a plurality of modules, said plurality of modules arranged into a plurality of layers, including an upper layer of modules and a lower layer of modules, said upper layer of modules being buoyant and said lower layer of modules being negatively buoyant in said seawater, each module being attached to at least one module vertically and at least one module horizontally to form the lattice structure; and a plurality of connecting members, each said connecting member attached to at least two vertically adjacent modules at respective connection points, and adapted for rotation around each said respective connection point; a mooring anchor attached to the sea floor; a tether attached between the anchor and the lattice structure; and a motion transducer adapted to convert rotational motion of said connecting members relative to said modules to electrical energy.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts a three-dimensional lattice structure tethered to the sea floor at one location, the interconnected lattice structure curving in reaction to the waves; in this embodiment, the tether is connected to the entire array at two locations along the lower level of modules;

FIG. 2 depicts a profile of a two-level, three-dimensional lattice structure of the device illustrating a chain-of-parallelograms effect, folding at respective corner joints of the parallelograms in reaction to the orbital motion of the waves; wherein the entire structure is tethered to the sea floor, including a representation of a spring, or spring-like, element within or on the tether line, according to an embodiment of the invention;

FIG. 3 depicts a close up of a two-level three-dimensional lattice structure, illustrating both the horizontal and vertical connections;

FIG. 4 depicts a three-level realization of the thee-dimensional lattice structure. where the arrangement of modules parallels that of an FCC (face centered cubic) structure, with rotating joints at each connection point to allow for the collapsing chain of parallelograms to follow the circular motion of the ocean waves; and

FIG. 5 depicts a three-level representation of the device in a three-dimensional interconnected lattice structure, where the arrangement of modules parallels a BCC (body centered cubic) configuration, as an example of alternative structure, whereby parallelograms formed by the vertical and horizontal interconnectedness of the multi-level structure conform to and follow the circular orbital path of ocean wave motion.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Nature provides us with highly strong, and durable materials. Through manipulation, and combination of materials we have been able to utilize these inherent strengths found in nature. Steel is a material that provides profound strength, durability, and flexibility in its available uses to us. Within steel there is a particular physical configuration that allows for both its strength and ductility, among other characteristics. This configuration is found in its lattice crystal structure, steel having a BCC (body-centered cubic) configuration, which lends it some of its strength. An example of another unique lattice crystal structure found in nature can be found in Aluminum, which has a FCC (face-centered cubic) structure. These are two, of other possible examples of crystalline configurations that can lend strength and other unique qualities to objects, or structures that may be utilized in the configuration of the present device.

The present wave energy convertor invention utilizes both the strength of a three-dimensional crystal-like lattice configuration, as well as utilizing this type of configuration for maximum energy extraction of ocean wave energy, by allowing relative rotational and/or linear motion between modules at each lattice connection point and/or within the connecting member itself. A variety of crystalline-like configurations can be used as this invention's operating structure, utilizing the energy capture method described. By having two, or more, layers of interconnected energy-capturing modules, with the lower-most layer moored to the seabed by a tether attached to the front-most modules of that layer, closest to the oncoming, incident waves (creating a “reaction” layer, limiting the complete surge, heave and therefore mass displacement of the lower layer(s), while still moving in synchrony, with an upper layer, and also allowing the entire connected lattice to swivel into the direction of the oncoming incident waves, facing the energy producing wave fronts), a maximum amount of the orbital water particle motion in an ocean wave can be captured. This orbital motion can be decomposed into heaving and surging motions. Due to the exponentially decreasing size of these orbitals of wave motion—with no effective orbital motion at a depth of ½ of the current wavelength—a lower layer that is tethered, provides for a greater circular/orbital capture of the largest displaced motion at the ocean surface. At each of the joints within a module, there is the individual ability to capture rotational motion which can be converted into usable energy. Each joint can utilize a universal joint, or constant velocity joint, or like device with up to three degrees of rotational freedom, allowing transverse ocean waves (producing “roll” in modules) to pass by/through the apparatus without affecting capture of wave energy via “pitch” of modules. “Yaw” is primarily facilitated via alignment of entire structure to face (incident) waves, though it may also be facilitated at module joints. These joints allow for any changes in angles of the incident waves, due to transverse waves present or other motion influences, to continuously be decomposed and translated into consistent rotational motion, and thus capture the primary energy available. These rotational motions can then be converted to electricity, via generators within each module, that is then sent back to shore for storage, or transmission, via transmission cables, or optionally stored at sea before transmission. The following coordinate system may be used: Pitch (around y) is the primary rotational motion of the modules induced by the motion of the ocean waves, creating the rotational movement that is converted to energy. The universal, or universal-like joints, allow for roll (around x) at connection points. Yaw (around z) is primarily accomplished via underwater mooring of the total lattice wave farm to the seabed (as described above), allowing the entire lattice structure to turn, and swivel, to face the structure in the direction of the oncoming waves, and additionally at each joint for complete freedom of movement, and alignment, with weathervane-like guides beneath each module, aiding in this direction finding.

As each wave passes an element, such as a surface module, the module moves toward the oncoming wave from its trough, lifting up with the increasing height, and riding the top of the wave in the direction of the wave motion, before returning again, and repeating its orbit. This motion was once thought to include no net translational motion, such that any object at sea would theoretically stay in one location, orbiting endlessly in relation to oncoming waves. It has since been found that there is indeed some net translational motion, known as mass transport. This net displacement is also known as Stokes drift, and can be calculated. Thus, orbits return from their path but at a small progression forward with the wave. This mass transport aids in keeping the lower tethered layer of the wave farm taut via the tether in relation to the mooring anchor, and aids in it being a steady reaction element to the upper layer, with primarily only the ability to surge back toward the oncoming waves a shorter distance than would otherwise be expected without mass transport, and heave upward, all at exponentially smaller radii than the orbits of the paths of the above layer(s). Thus, even at this surge portion of a motion arc, there is still a differential between upper and lower modules of distance traveled, greater than would otherwise be expected by orbital size, in horizontal surge, as the orbit returns toward the incident approaching waves. The portion of motion moving with the wave direction allows for full capture of that half of the surge (horizontal, x direction) component of the orbit because of the taut nature of the lower layer during this part of the circular/orbital cycle. As the upper layer surges in relation to the/a lower layer, rotation occurs via the joining connecting members, at each module's joints, complementing the contributed motion from the surface modules riding the waves themselves as the two, or more layers heave in synchrony. As an addition, another seabed mooring connected to the surface layer of modules (also allowing yaw, and swivel movement of the total lattice structure), with a tether allowing elongation, with a force to return it to initial length, may be useful in both preventing extreme angles between the aligned layer of surface modules in relation to the submerged layer(s), and in returning energy to the system made available during the mass transport effect via a restoration force. The heave (vertical, z direction) components of the orbital path traveled by water particles are captured in the rotation at the joints, via being fundamental components of the complete orbital water path. As the modules ride over the oncoming waves, they take on the shape of the wave, including rising and falling with the changing wave height. This creates rotation relative to each module member at their joints. The lack of buoyancy of lower layer(s) allows further resistance to these movements, allowing maximum torque potential for gear multiplying within each module. All rotational energy-generating motions can then be mechanically or electronically summed within each module, via ratcheting and/or other system, to fully utilize the maximum potential of available motion energies. Thus, more than one sea bed anchor may be used to advantage with the apparatus of the invention, and more than one tether, connected to more than one layer of the lattice structure, without departing from the scope of the invention.

Telescoping connecting members, as opposed to completely rigid connecting members which also may be utilized (both with the potential for the same universal, or universal-like connecting joints at connecting points to modules), can allow for the maximum capture of energy in ocean wave water particle motion between lower and upper layer(s). The telescoping connecting elements' motion between lattice layers can be calibrated in real time for optimum operating range, in relation to wave conditions, to allow for adaption to various wave heights or other oceanographic or atmospheric conditions present via feedback sensors, or remote commands sent to the wave farm itself (picked up by receivers located with transmitters on the modules themselves), or be preset according to wave field typical conditions. The apparatus could also retract these telescoping members to allow for greater durability during extremely rough, and destructive conditions, if necessary, to improve the longevity and preserve the strength of the apparatus. Ideally these connecting members' lengths are not set, but rather may calibrate themselves to the most efficient energy generating length and operating range and modified to achieve maximum energy absorption of energy in circular ocean wave orbits by matching the greatest displacement of the circular orbital arcs available that is possible. The optimal distance between layers is set to take advantage of the limited depth of orbital motion in an ocean wave, which disappears at a depth equal to one half of the length of the wave.

The growing need for ocean wave mitigation solutions, for coastal municipalities and communities requires new, original ideas and solutions. Baked into the very design of this crystal-like lattice structure wave energy converter is the resiliency required to survive extreme ocean wave conditions. The device has an inherent three-dimensional interconnectivity, and density of spacing within the apparatus, across potentially large ocean areas that allows it to ideally function as a wave dampening solution to lessen the magnitude of destructive forces encountered during extreme weather conditions, while at the same time capturing the energy the apparatus is dissipating from the waves Groupings of offset arrays of lattice structure configurations of modules, allows for a multilayered, multi-stage reduction of wave energy as the waves reach each spaced-apart array of modules, thereby down-stepping the energy in multiple stages in order to both capture as much energy as possible from the waves' motion, and by doing so deplete and reduce the energy content of the waves and their ability to cause destruction at the shoreline.

The apparatus includes a motion transducer adapted to convert rotational motion of the connecting members relative to the modules to electrical energy. There are typically two ways to convert the motion of the ocean waves, when captured, into power. One involves utilizing the rotation that is harvested in an induction generator directly, whereby electricity is produced via an arrangement of magnets in the generator in which a relative motion is produced between the magnets in relation to the electrical wiring current path in the generator, this all facilitated via the rotational motion directly captured by the device. Because rotation is typically two-way in direction when capturing oscillating ocean waves, a form of gearing is often utilized such that it turns the two-way rotation captured into one-way motion before entering the generator. Generators may also be “coded” in the arrangement of the magnets and wiring, meaning it utilizes a unique relative wiring-magnet arrangement, such that one-way direct current electrical current output is created despite the two-way rotational input. Another electronic means for creating a one-way direct current output can be achieved via electronic circuitry means, such as with a bridge-rectifier circuit design, whereby alternating current input into the circuit is converted to direct current output. This allows the two-way alternating electrical current output of a generator, created from a two-way rotational motion input, to be converted to direct current electricity after the electrical induction generation in the electricity-creating chain. Hydraulic means are another typical method for utilizing the energy captured in an ocean wave and changing it into usable electricity. Rotational motion captured by the wave energy converter device can be utilized to increase pressure in a fluid such that it drives a turbine, which then drives a generator. Each rotation connection point between a module and a connecting member within an array of modules will have its own generator within said respective module, or gearing may be utilized to mechanically sum the motion of all rotation points within a module, to feed one singular generator per module, or any variety of configuration thereof within a module. Any of the above listed methods may be utilized with an apparatus according to the invention to convert the motion and energy captured into a usable, transmittable form of electricity.

In embodiments, means are provided, such as an electrical cable, to carry captured electricity from the apparatus to land. Once electricity is electronically summed between energy generating modules, via interconnected electrical wiring between modules, a single output electrical line will emerge from each array, or subset of modules within an array, and be sent and transmitted via undersea cable to land for its utilization, or to a storage outpost at sea, which may be located at the energy generation site. These undersea cables lay across the sea floor to send electricity back to shore utilizing established marine technology for the laying of undersea cable and the maintenance thereof.

The one or more tether attaching the apparatus to the sea floor may be provided with a linear and/or nonlinear spring element. Although a linear spring is schematically depicted in the figures in combination with the tether, other options and technologies may be used. It may be more than a linear spring constant that comes into play in these modern mooring technologies. There is also non-linear damping that can be included in the mooring/cabling, providing damping potential more generally of the mooring lines. With this response the tether remains flexible at low elongations, responding freely across the lower sea states, but smoothly changes stiffness to deliver the stiffer high load response during storm scenarios.

These modules' optional receiving and transmitting capability could also be used to remotely control various other parameters and settings on the modules themselves, or at any place in the apparatus, to respond to various wave conditions, or energy needs. As well, sensors may be located on the apparatus itself in order to relay current oceanographic and atmospheric conditions back to shore.

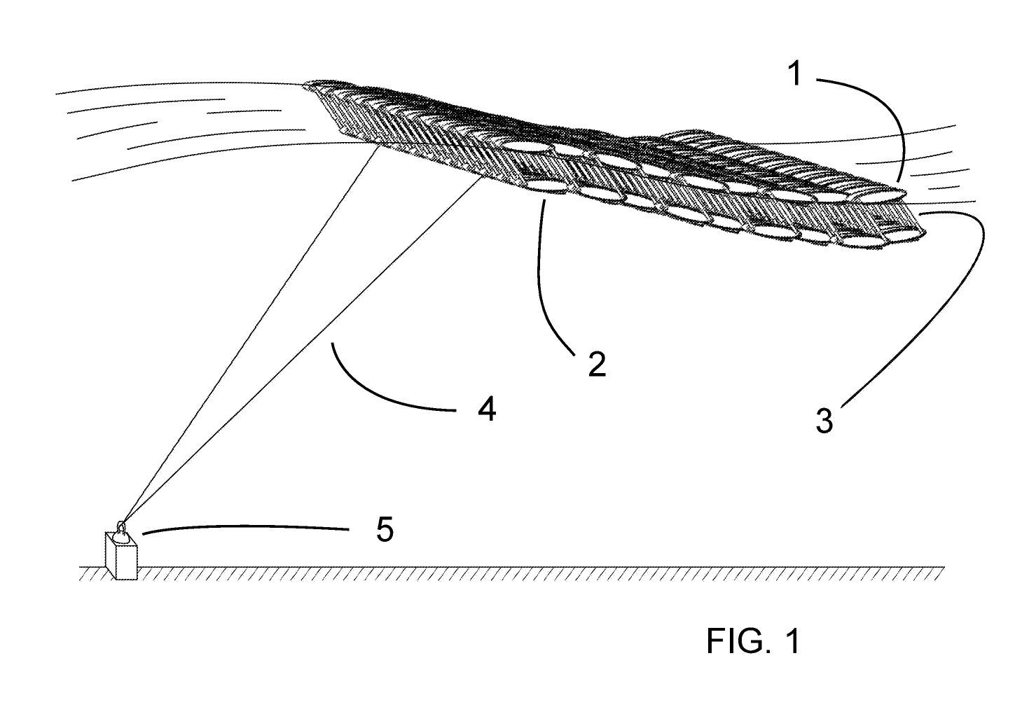

In a representative embodiment of the invention according to FIG. 1, a lattice structure is shown formed from a layer of buoyant modules 1 connected to a layer of negatively buoyant modules 2 by connecting members 3. A mooring anchor 5 attached to the sea floor is connected to the lattice structure by tether 4. In the embodiment, two components of the tether are connected to the layer of negatively buoyant modules. However as discussed in the detailed description above, many variations in the attachment of the tether to the lattice structure may be employed to advantage.

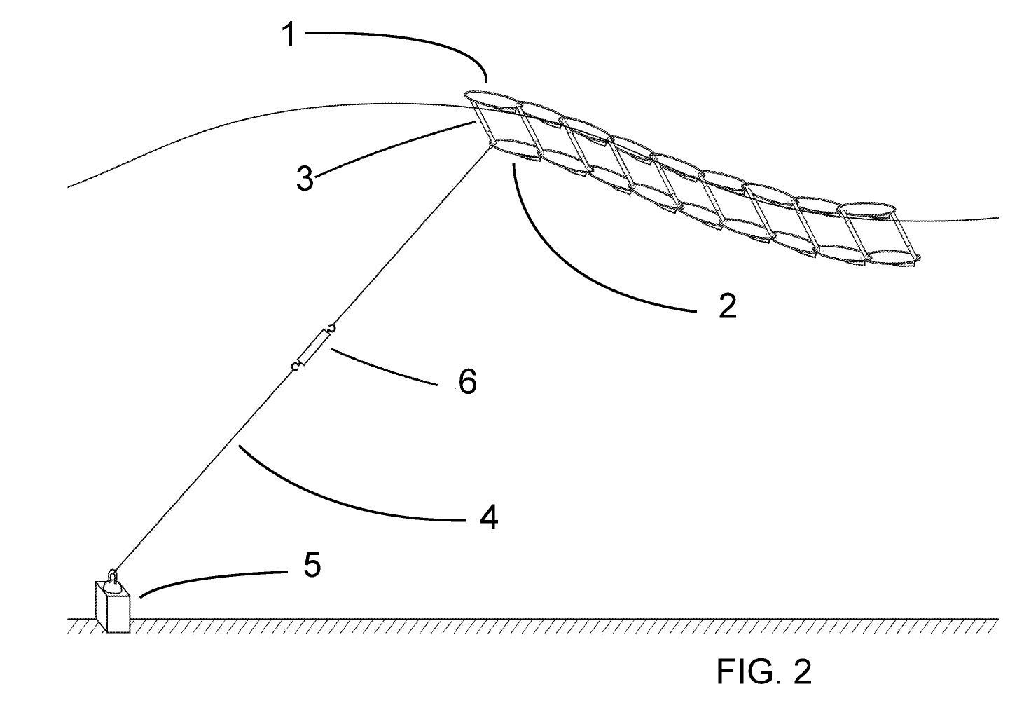

In a representative embodiment of the invention according to FIG. 2, a lattice structure is shown formed from a layer of buoyant modules 1 connected to a layer of negatively buoyant modules 2 by connecting members 3. A mooring anchor 5 attached to the sea floor is connected to the lattice structure by tether 4. In the embodiment, one component of the tether is connected to the layer of negatively buoyant modules. However as discussed in the detailed description above, many variations in the attachment of the tether to the lattice structure may be employed to advantage. A visual representation of a linear and/or non-linear spring, or spring-like element 6 is incorporated within, and/or attached to the tether. However as discussed in the detailed description above, many variations in the inclusion of the spring, or spring-like element within or attached to a particular tether may be employed to advantage.

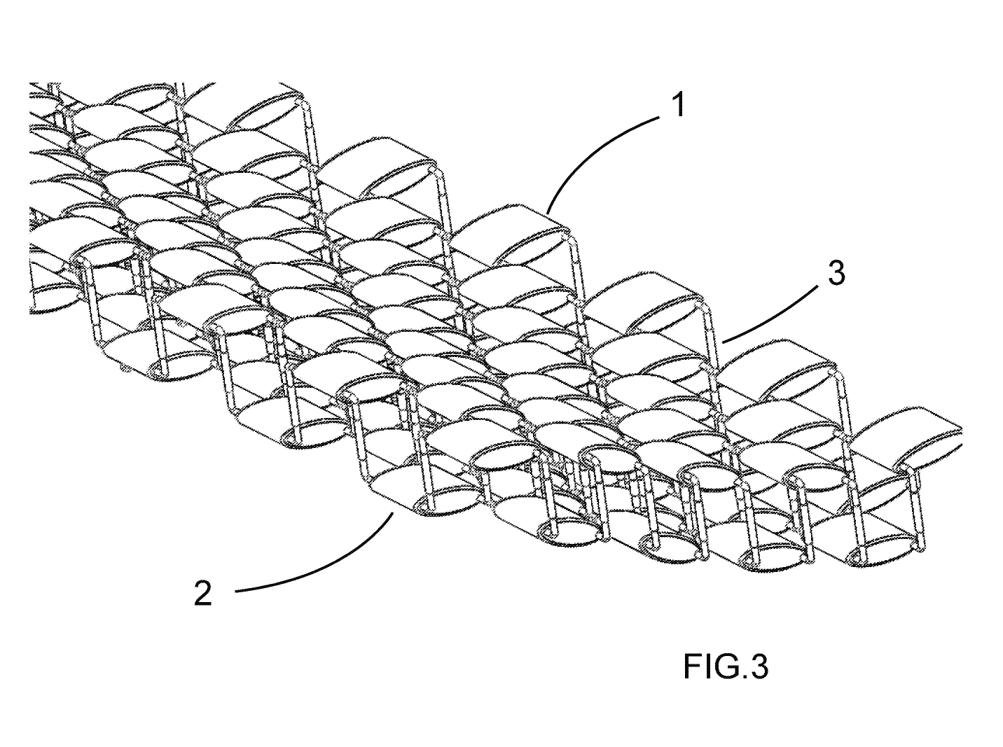

In a representative embodiment of the invention according to FIG. 3, a lattice structure is shown formed from a layer of buoyant modules 1 connected to a layer of negatively buoyant modules 2 by connecting members 3.

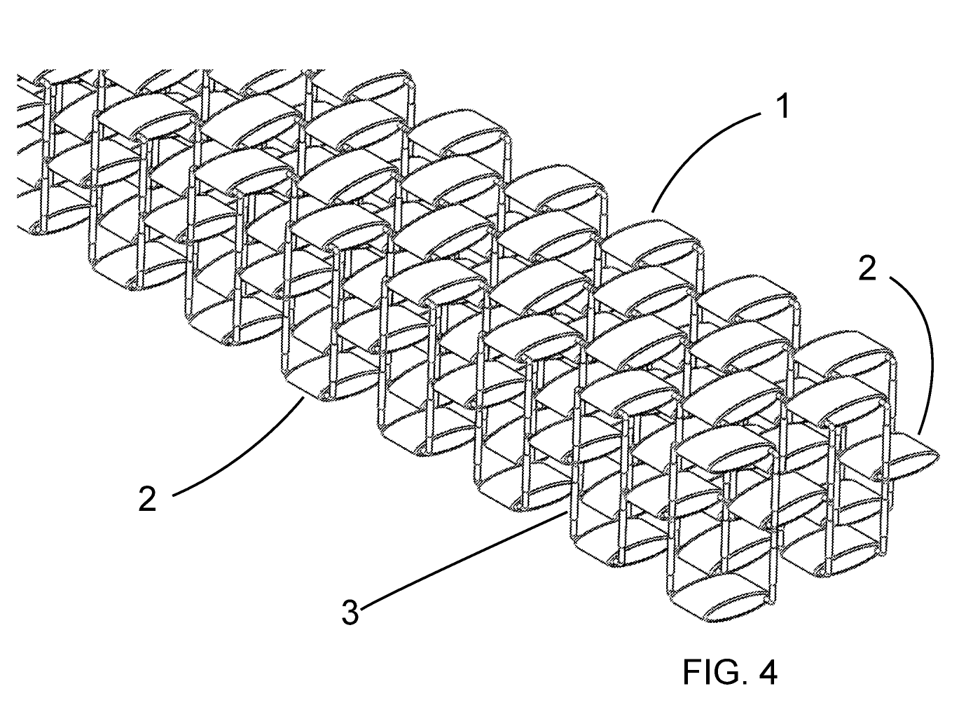

In a representative embodiment of the invention according to FIG. 4, a lattice structure is shown formed from a layer of buoyant modules 1 connected to layers of negatively buoyant modules 2 by connecting members 3, in a multi-layered arrangement.

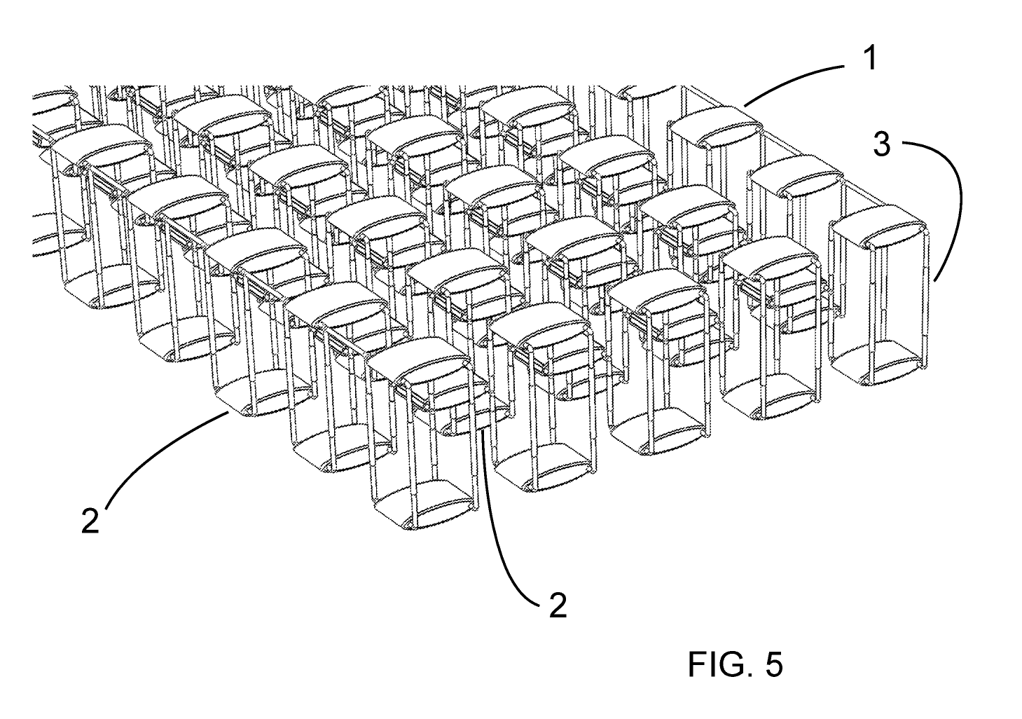

In a representative embodiment of the invention according to FIG. 5, a lattice structure is shown formed from a layer of buoyant modules 1 connected to layers of negatively buoyant modules 2 by connecting members 3, in an alternative multi-layer arrangement to FIG. 4.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Features of the invention described with reference to one embodiment may be combined with a different embodiment without departing from the scope of the invention. Likewise, a feature set forth in a dependent claim may be combined with a different independent or dependent claim(s) without departing from the scope of the invention.

1. An apparatus for extracting power from wave motion in seawater over a sea floor, comprising:
a lattice structure comprised of a plurality of modules, said plurality of modules arranged into a plurality of layers, including an upper layer of modules and a lower layer of modules, said upper layer of modules being buoyant and said lower layer of modules being negatively buoyant in said seawater, each module being attached to at least one module vertically and at least one module horizontally to form the lattice structure; and
a plurality of connecting members, each said connecting member connected to adjacent modules at respective connection points, and adapted for rotation around each said respective connection point;
a mooring anchor attached to the sea floor;
a tether attached between the anchor and the lattice structure; and
a motion transducer adapted to convert rotational motion of said connecting members relative to said modules to electrical energy.

2. The apparatus according to claim 1, wherein at least one connecting member comprises telescoped tubes adapted to change length in response to the wave motion.

3. The apparatus according to claim 1, wherein at least one of the connection points is a universal joint permitting rotation of said connecting member around x, y, and z axes.

4. The apparatus according to claim 1, wherein at least one of the modules is provided with a vane for orienting the modules with respect to an oncoming direction of the waves.

5. The apparatus according to claim 1, further comprising an electrical cable transporting electrical current from said apparatus to land.

6. The apparatus according to claim 1, wherein the motion transducer comprises generators within a majority of the modules in the lattice.

7. The apparatus according to claim 1, wherein each module comprises a plurality of connection points.

8. The apparatus according to claim 7, wherein each module comprises four connection points, and wherein each of said connection points is adapted for attachment to one end of a connecting member.

9. The apparatus according to claim 1, wherein the tether comprises a linear and/or non-linear spring element.

10. The apparatus according to claim 1, wherein the tether is attached between the anchor and the upper layer of the lattice structure; between the anchor and the lower layer of the lattice structure; or between the anchor and the upper and lower layers of the lattice structure.

11. The apparatus according to claim 1, wherein the lattice has a front side facing oncoming waves and wherein the apparatus further comprises a second tether; and
wherein
the tether is attached between the anchor and the upper layer of the lattice structure; and
the second tether is attached between the anchor and the lower layer of the lattice structure.

12. The apparatus according to claim 10, wherein the tether, the second tether, or both is provided with a linear and/or nonlinear spring element.

13. The apparatus according to claim 1, further comprising lateral connecting members connected between two modules in the upper layer, the lower layer, or both.

14. The apparatus according to claim 1, wherein the connecting members have an adjustable length adapted to adjust a vertical distance between the upper layer and the lower layer of the lattice in accordance with wave conditions of the ocean waves.

15. The apparatus according to claim 1, wherein said plurality of layers includes at least one layer of modules between said upper and lower layers.

16. The apparatus according to claim 1, comprising a plurality of tethers connected to the lattice structure and to a common point on the sea floor, orienting the modules with respect to an oncoming direction of the waves.

17. The apparatus according to claim 1, wherein the plurality of modules is arranged in a crystalline pattern.

18. The apparatus according to claim 17, wherein the plurality of modules is arranged in a face centered cubic or body centered cubic crystalline pattern.
